(19) United States
(12) Patent Application Publication
(10) Pub. No.: US 2022/0396462 A1
(43) Pub. Date: Dec. 15, 2022

(54) Slip & Cut (Khort)

(71) Applicant: Elivelton da Silva, Bowie, MD (US)

(72) Inventor: Elivelton da Silva, Bowie, MD (US)

(21) Appl. No.: 17/344,968

(22) Filed: Jun. 11, 2021

(51) Int. Cl. B67B 7/46; B26B 27/00

(52) U.S. Cl. CPC B67B 7/30; B26B 27/00

(57) ABSTRACT

An assembly for cutting the packets like by trimming off an end portion of a closed edge of said packet using cutting means. It uses at least one trimming blade (1) and plastic body (2), where the blades are movable in a reciprocating manner one against the packet top which is inserted into the machine body.

### BACKGROUND

### Field of the Invention

The present invention relates to a packet opener and more particularly relates to an automatic apparatus for opening packets or the like by trimming off an end portion of a closed edge of said packet using trimming means.

### Description of the Related Art

Packages for food products are well known from the prior art and primarily serve the purpose of conserving the freshness and taste of the packed product. Therefore, the packages are often sealed and thus impermeable to moisture and gas.

By looking at prior art multiple types of structures have been seen regarding opening of packets. Such apparatuses are well known in the art and widely used, but they suffer from certain drawbacks. A cutting apparatus, particularly for use with packets, has two opposed counter-rotating circular blade, which perform the opening action by trimming along a closed edge of the packet as follows: a user introduces one border of the packet between two counter-rotating blades, which drive the packet thereunder, while cutting off the packet border projecting out of one of the two of the counter-rotating blade pair, whereby the packet is opened on such side. The first drawback of this prior art apparatus is that it is unsuitable for cutting enclosures that contain materials other than paper sheets, or the like. Particularly, when the prior art apparatus is used with packets containing loose materials, such as powdery or granular solids, e.g. sugar, salt or the like, or liquid materials, such as ketchup, mayo and mustard packets, honey or the like, it causes such materials to pour off. The two counter-rotating circular blades rotate at a high speed and, as they drive the packet therebetween, they impart a high speed to the packet, and cause the packet to be shaken. While this shaking motion is not critical when the contents include paper sheets, such as with envelopes or the like, it inevitably causes a partial content loss if such contents include loose materials, such as fluids (e.g. sauces or honey), powdery or granular materials (e.g. sugar, salt or the like). Furthermore, as the packet is pulled into the gap between the two counter-rotating blades, such blades also somewhat press upon it and can cause the loose material to pour off when the packet is cut open. A further drawback is that, in operation, prior art apparatuses are controlled by a switch that turns the apparatus on and continuously operates it until the apparatus is turned off using the same switch. The two counter-rotating circular blades are thus rotated by turning on the apparatus, regardless of the presence of an enclosure to be opened therebetween. Therefore, these prior art apparatuses are prone to early wear, and further involve undue power consumption even in idle conditions, thereby causing energy waste.

There are multiple solutions that have been presented in prior art. However, these solutions are limited and restricted to their conventional architecture, installation system and have considerable shortcomings which adversely affect the convenience with which they can be used. The prior systems have certain limitations including the design of assemblies which make them not suitable for every type of user. Moreover, the ease-of-use ability of these assemblies is also questionable.

It has to be noted that the current invention proposes an assembly with an advancement where the design allows the user to open the packet easily without using hand force or teeth assistance. The carefully designed plastic and blade assembly can assist the user to open packets easily and freely.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a. novel and improved form of a packet opener.

Another object of the present invention is to provide an apparatus as described hereinbefore that uses simple and inexpensive arrangements to obviate prior art drawbacks, and is particularly suitable for discontinuous use and with packets also containing either loose, particularly powdery or granular materials, or liquid materials, such as ketchup, mayo, mustard packets, honey, sauces or the like.

Another object of this invention is to provide a new and improved assembly by providing an automatic apparatus for opening packets or the like, particularly packets containing powdery or granular materials, or liquid materials, such as ketchup, mayo and mustard packets.

It is an object of the present invention which may be constructed for various purposes and for packets of various sizes. According to an advantageous embodiment, this apparatus acts as a device for opening packets of powdery or granular materials, such as sugar packets.

It is another objective of the invention to provide a hygienic way to open any packet.

It is another object to provide a reliable construction which includes the structure developed from reliable material and can sustain its effectiveness over longer period of time.

Yet another object of the present invention is to provide a structure that is relatively inexpensive to produce so that ownership is available to a substantial majority of families.

It is also the objective of the invention to provide a smart assembly which provide ease of use and convenience to everyone.

Thus, it is the objective to provide a new and improved assembly with additional advancement. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a front perspective view of a slip and cut assembly showing my new design;

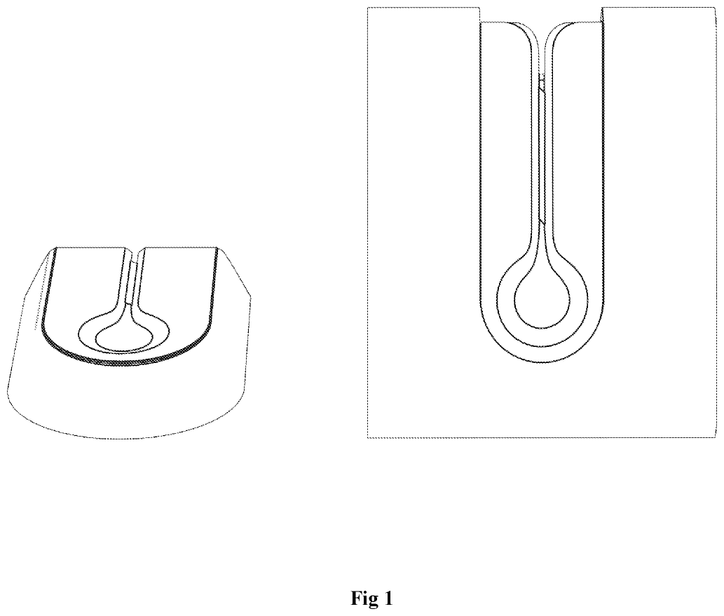

FIG. 2 shows front elevational view thereof;

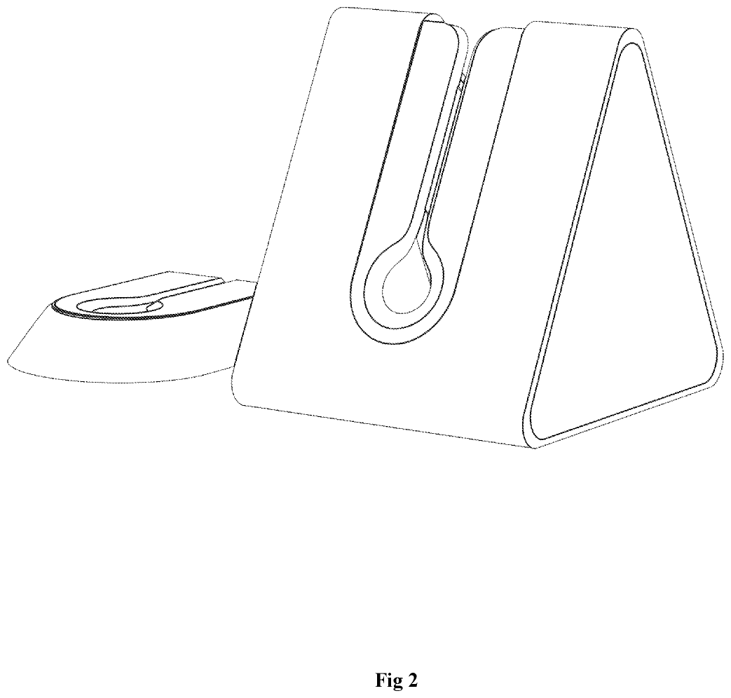

FIG. 3 is another elevational view thereof;

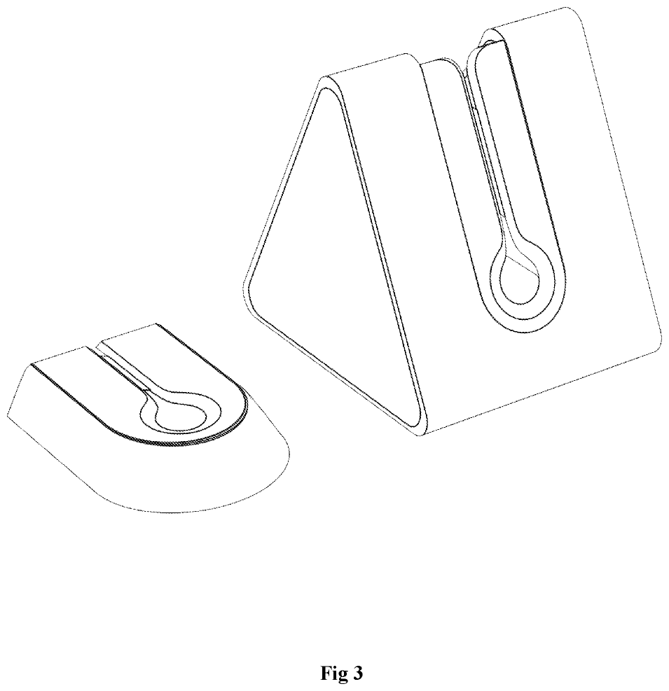

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide an improved assembly for opening packets of various kinds. The present invention advantageously allows a user to hygienically open packets without pouring out their contents over the counter, because the apparatus of the invention allows the packet to be opened without being shaken as it is cut open. Advantageously, to prevent any spillage of the packet contents, when these are in granular or liquid form, packet surface pressing means may be provided at the cutting plane for said surfaces to be driven towards each other and pressed together before trimming, to prevent any spillage. These compression means are located level with the slit for introducing the packet, and particularly the compression means are located between the cutting plane and the wall that contains the aperture for introducing the packet.

The compression means may consist of a pair of plates with a straight or slightly curved or arched shape, and are moved towards each other by such a translational motion as to compress together the edges of the packet. The plates are driven by the same means for driving the trimming means, so that they can be operated at the same time as or immediately before trimming.

Like the trimming means, the compression means are located in a case, to avoid accidental contact thereof with the fingers of a user and, in addition to keeping the packet contents far from the cutting line to avoid accidental content spillage, said means are also used to lock the packet in position at the slit and prevent it from being dragged along during operation of the blades.

According to a further embodiment, this apparatus acts as an apparatus for opening packets containing liquid materials, e.g., for opening packets containing honey or sauces or the like. This embodiment may advantageously find application to the case in which the apparatus is used, for instance, to open ketchup, mayo and mustard packets or the like.

In addition to the preferred embodiments as described above, the apparatus of the present invention may be constructed according to different variant embodiments of the cutter and associated counter-cutter.

This packet cutting operation is highly advantageous, as it minimizes shaking of the packet and prevents spillage of its contents, while allowing the packet to be opened in an automatic and hygienic manner.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: An automatic apparatus for opening packets or the like by trimming off an end portion of a closed side of said packet sing trimming means, particularly designed for opening packets or the like, particularly packets containing powdery, granular or liquid materials, comprising at least one trimming blade (l) and plastic body (2).

II: An assembly for accurately cutting the packets irrespective of shape and size with the use of cutter assembly. This promotes safe and hygienic way of opening any type of packet without the spillage and loss of material.
